(19) United States
(12) Patent Application Publication
(10) Pub. No.: US 2013/0118476 A1
(43) Pub. Date: May 16, 2013

(54) Outdoor fireplace

(71) Applicants: Richard Allen Wise, Tulsa, OK (US); Michael Erlin Wise, Swanton, OH (US)

(72) Inventors: Richard Allen Wise, Tulsa, OK (US); Michael Erlin Wise, Swanton, OH (US)

(21) Appl. No.: 13/373,288

(22) Filed: Nov. 10, 2011

(51) Int. Cl. F24B 1/195; B23P 11/00

(52) U.S. Cl. 126/552; 29/464; 126/500

(57) ABSTRACT

An outdoor fireplace is disclosed, the outdoor fireplace including a housing chamber having walls formed from a natural stone material and a metal insert disposed in the housing chamber to militate against a transfer of heat to the natural stone material and further surrounding area.

### FIELD OF INVENTION

The present invention generally relates to outdoor fireplaces and, more particularly, to an outdoor fireplace which preferably incorporates a unique interlocking, self-supporting, ventilating outer shell of natural stone, and an inner shell incorporating a steel firebox to reduce heat transfer, and flame contact from the interior side, top and bottom of the unit to the surrounding area.

### BACKGROUND OF THE INVENTION

Outdoor fireplaces are often used to provide warmth, improve the ambiance of an outdoor setting, and provide an open flame over which to cook, or burn items as a means of disposal.

It is not unusual for outdoor fireplaces to be used on decks and patios, which frequently have finished surfaces, such as wood that can be readily discolored or damaged when exposed to elevated temperatures. In addition, prolonged exposure to moderate temperatures may suffice to degrade the finish as well.

Typical outdoor fireplaces have a combustion chamber that utilizes a single layer of material that readily transfers heat to the surrounding areas. Further, due to safety concerns, it is desirable to maintain a low center of gravity, and thereby stability, for the outdoor fireplace and combustible materials being burned therein.

Typical outdoor fireplaces are frequently designed such that the floor of the combustion chamber is supported only a short distance from the underlying support surface. This further contributes to the radiant transfer of heat to the underlying surface. Further prior art requires tools, fasteners, or adhesives for assembly, thereby relying on the assembler to posses the necessary equipment and wherewithal to complete proper assembly.

Further outdoor fireplaces are susceptible to deterioration from the external elements, such as wind, rain, and freezing temperatures, and the combustion process, thereby causing failure of coatings, fasteners, supports, adhesives, and retainers of these units.

Therefore there is a need for providing an improved outdoor fireplace to address these shortcomings of the prior art.

### SUMMARY OF THE INVENTION

Briefly described, the outdoor fireplace provides an apparatus for burning appropriate combustible materials. An embodiment includes a combustion chamber, made of a steel liner disposed in a natural stone base structure. The outdoor fireplace is made of two sides that support a base, which supports the rear of the assembly. The lower sides also support a middle base that is parallel to the bottom, which interlocks the rear piece, to provide stability. The top section of the outdoor fireplace is then interlocked to the middle section, thus providing the chimney to evacuate the combustion gases.

The top section is made of two sides that interlock to the supporting middle section and then to the face piece, which in turn interlocks to the middle supporting section. The top assembly is then secured to the rear piece, which extends from the bottom section to the top of the outdoor fireplace by a stone cap, which is placed over the interlocking chimney sections. The outdoor fireplace described utilizes no fasteners, adhesives, or tools in its assembly, and the exterior structure is of a natural stone thereby mitigating the effects of natural weathering to the present invention.

Other objects, features, and advantages will become apparent to one with skill in the art upon examination of the following drawings and detailed description. It is intended that all such objects, designs, features, and advantages be included herein within the scope of the present invention, as described in the appended claims.

### BRIEF DESCRIPTION OF THE DRAWINGS

The above, as well as other objects and advantages of the invention, will become readily apparent to those skilled in the art from the following detailed description of an embodiment of the invention when considered in the light of the accompanying figure, in which:

FIG. 1 is a front perspective view of a preferred embodiment of the present invention.

FIG. 2 is a front view of the outdoor fireplace shown in FIG. 1;

FIG. 3 is a right view of the outdoor fireplace shown in FIG. 1;

FIG. 4 is a left view of outdoor fireplace shown in FIG. 1;

FIG. 5 is a rear view of the outdoor fireplace shown in FIG. 1;

FIG. 6 is a bottom view of the outdoor fireplace shown in FIG. 1;

FIG. 7 is a top view of the outdoor fireplace shown in FIG. 1;

FIG. 8 is an exploded perspective view of the lower section of the outdoor fireplace shown in FIG. 1;

FIG. 9 is an exploded perspective view of the upper section, and metal insert of the outdoor fireplace shown in FIG. 1; and

FIG. 10 is a front perspective view illustrating use of an approved fuel system insert in lue of the metal insert.

References will now be made in detail to the description of the outdoor fireplace as illustrated in the drawings. While the outdoor fireplace will be described in connection with these drawings, there is no intent to limit it to the embodiment or embodiments disclosed herein. On the contrary, the intent is to cover all alternatives, modifications and equivalents included within the spirit and scope of the outdoor fireplace as defined by the appended claims.

### DETAILED DESCRIPTION OF THE INVENTION

References will now be made in detail to the description of the invention and illustrated in the drawings with like reference numerals indicating like parts throughout the several views.

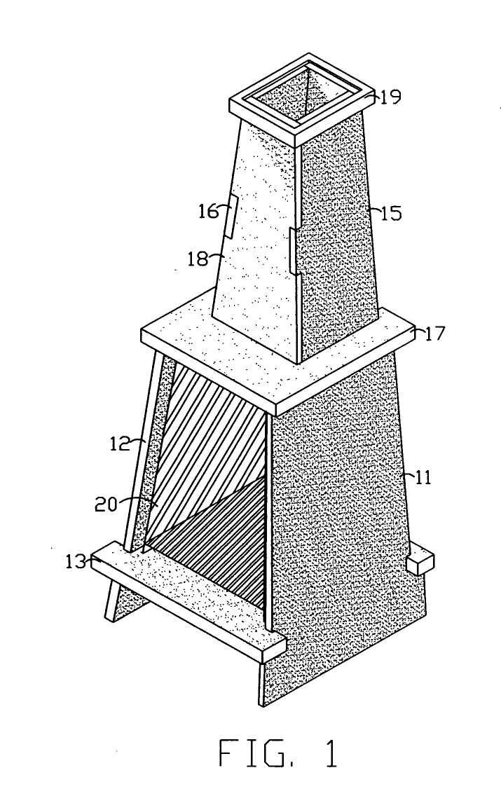

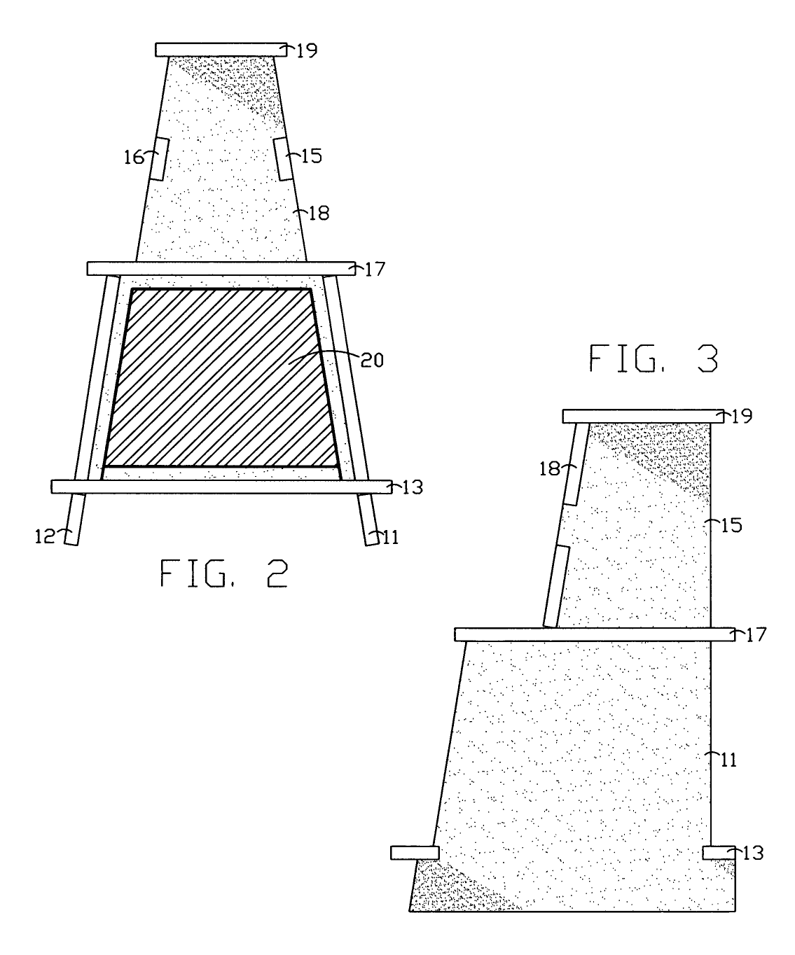

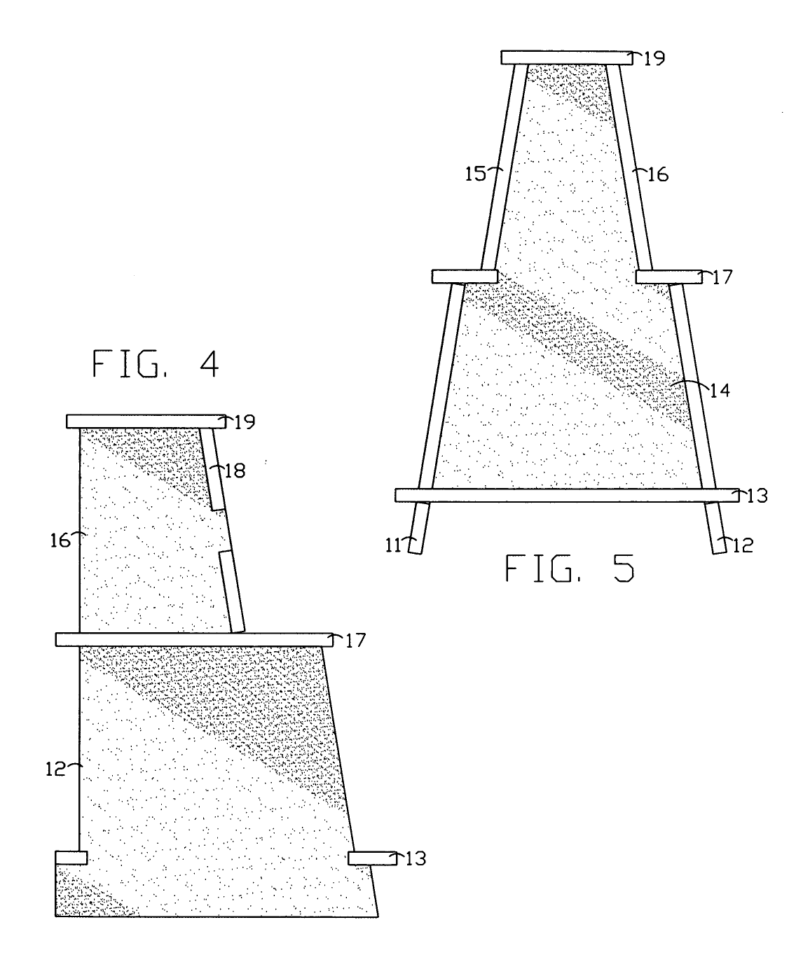

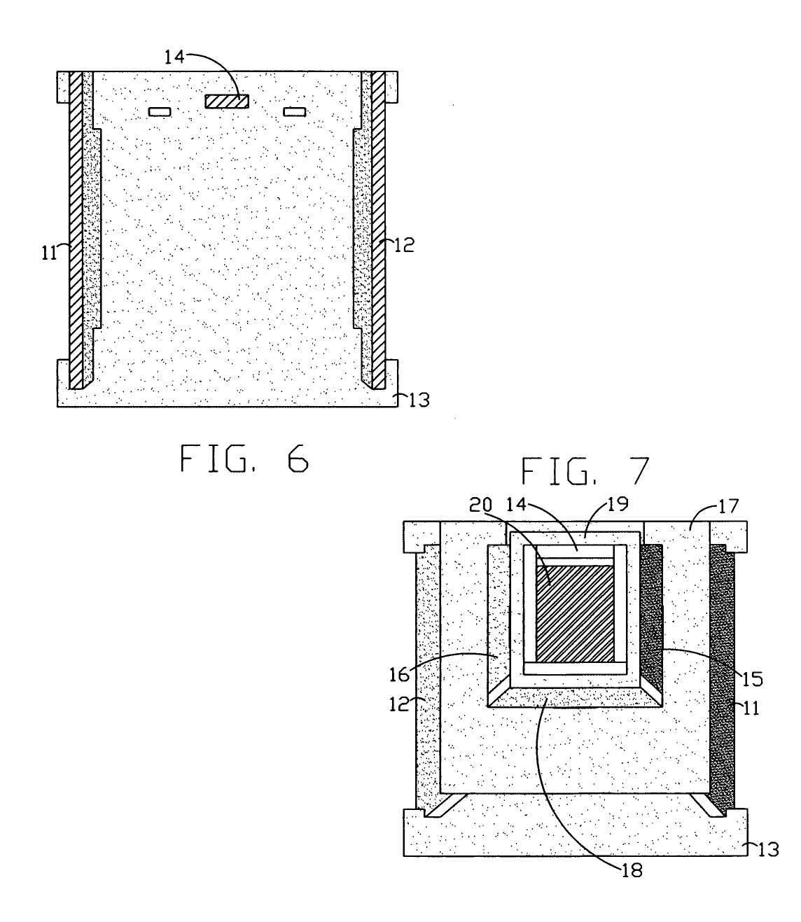

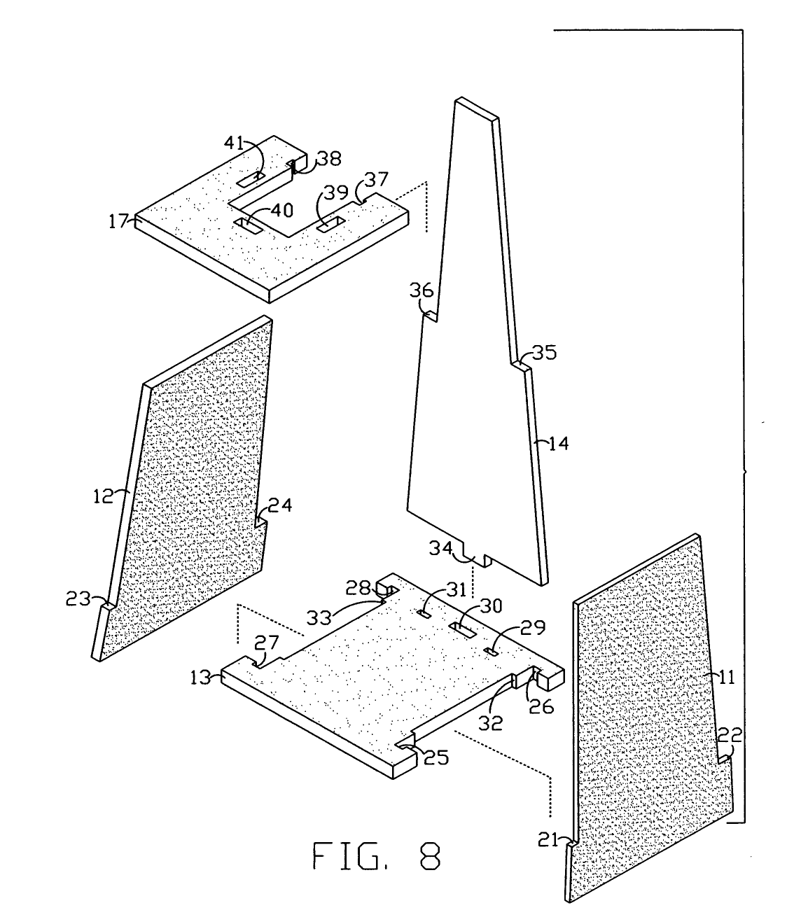

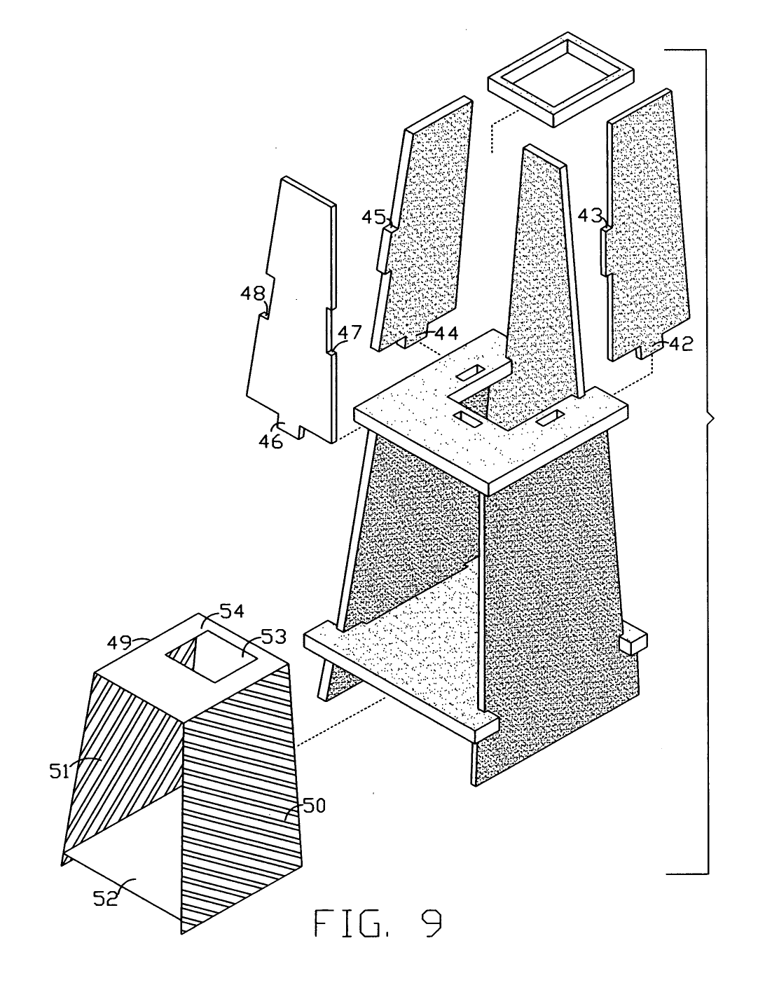

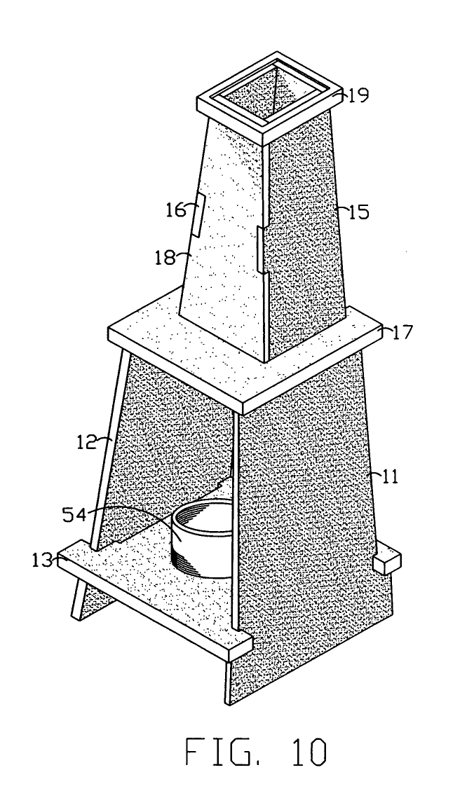

As shown in FIG. 1-10, a preferred embodiment of the outdoor fireplace the present invention incorporates a lower base 13, which interlocks with the bottom right side 11, at notches 25, and 26, resting upon projections 21, and 22 respectively. The lower left side 12, accepts the lower base 13, at notches 27, and 28, resting upon projections 23, and 24, respectively. Upon assembly of 11, 12, and 13, the back 14, is then lowered into the notch 30, which receives projection 34, of back 14. At this step of assembly lower bases 11, and 12, are then pivoted into final resting position abutting their adjacent edge of lower base 13. Middle base 17, is then nested on top of lower sides 11, 12, and back 14. Middle base 17, utilizes notches 37, and 38, to lock at insets 35, and 36, of back 14. Upper right side 15, is lowered onto middle base 17, utilizing notch 39, which receives projection 42, of upper right side 15. Upper face 18, is lowered onto middle base 17, utilizing notch 40, which receives projection 46, of upper face 18. Upper left side 16, is lowered onto middle base 17, utilizing notch 41, which receives projection 44, of upper left side 16. At this step of assembly upper right side 15, pivots to adjacent edge of back 14, and upper face 18, which then nests projection 43, of upper right 15, to corresponding notch 47, of upper face 18. Upper left side 16, pivots to adjacent edge of back 14, and upper face 18, which then nests projection 45, of upper left side 16, to corresponding notch 48, of upper face 18. Upper face 18, pivots towards back 14, coming to final assembly position against upper sides 15, and 16. These pieces, when assembled, provide the chimney with which the combustion gases will exit the outdoor fireplace. Cap 19, is then lowered onto fully assembled upper sides 15, and 16, and back 14, thereby securing the assembled exterior. The metal insert 20, comprised of two identical sides 49, and 50, base 51, rear 52, and top 53, which having been securely assembled are inserted into the lower cavity of the exterior shell thereby providing a combustion chamber for the present invention. Metal insert 20, rests upon lower base 13, and is centered in the lower cavity, between notches 29, 31, 32, and 33. When placed in this position the metal insert 20, is provided sufficient airflow from beneath the present invention to reduced heat transfer to the corresponding structure.

Another variant of this invention, shown in FIG. 10, replaces metal insert 20, with an approved fuel system 54, to provide heat and ambiance, while present invention is located within an interior setting.

The foregoing description has been presented for purposes of illustration and description. It is not intended to be exhaustive or to limit the invention to the precise forms disclosed. Obvious modifications or variations are possible in light of the above teachings. The embodiment or embodiments discussed, however, were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled.

What is claimed is:

1. A method for making an outdoor fireplace/“Granimea” comprising:
an exterior housing chamber formed from natural stone materials; and
a metal combustion chamber disposed in the housing chamber to militate a transfer of heat to the natural stone material and further surrounding areas.

2. A method of producing an outdoor fireplace, the method comprised of the steps of:
providing two sides upon which a base rests and into which the rear/back is placed into a precut notch, providing a middle placed parallel to the base and perpendicular to the rear/back in such a manner as to lock into place and provide a base for the chimney section to rest upon;
the chimney assembly shall be placed into the corresponding precut notches upon the middle and then interlocked into the face piece and completed with the Cap, which sets parallel with the base and middle, and perpendicular to the rear/back;
a combustion chamber made up of a metal insert, utilized to militate the transfer of heat to the adjacent natural stone assembly that comprises the main body of the outdoor fireplace to complete the assembly process without use of tools, fasteners, or adhesives.

3. The use of a natural stone for the outdoor fireplace to mitigate deterioration from natural weathering and the effects of combustion contained inside the metal insert.
